(19) United States
(12) Patent Application Publication
(10) Pub. No.: US 2005/0170085 A1
(43) Pub. Date: Aug. 4, 2005

(54) Process for producing a plastic pellicle and/or film in a continuous cycle in the print finishing of hides, synthetic materials or any other support

(76) Inventor: Bruno Zanella, Verona (IT)

Correspondence Address: NOTARO AND MICHALOS, 100 DUTCH HILL ROAD, SUITE 110, ORANGEBURG, NY, 10962-2100, US

(21) Appl. No.: 11/042,224

(22) Filed: Jan. 25, 2005

(30) Foreign Application Priority Data
Feb. 4, 2004 (IT) VR2004A000014

(51) Int. Cl. B05D 5/06

(52) U.S. Cl. 427/164

(57) ABSTRACT

A process is proposed to produce a plastic pellicle and/or film in a continuous cycle in the print finishing of hides, synthetic materials or any other support in which the printed patterns or other decorative elements are included in at least two film layers.

The present invention refers to a process for producing a plastic pellicle and/or film in a continuous cycle in the print finishing of hides, synthetic materials or any other support.

As is known, the market offers several types of pre-formed plastic pellicles or films to colour paper, cloth, hide and whatever kind of support on which the film is placed.

The said pre-formed pellicles or films are available in several colours, base and neutral colours, and are applied to the support by transferring the image or colour through known systems and methods such as dry transfer, hot transfer, cold transfer, pressure and so on.

However, the subject films have many disadvantages. The main disadvantage is the impossibility of obtaining the said films in a continuous cycle simultaneously with the coupling on the final support.

A further disadvantage is that the said films, which are produced in the wished colours and visual elements with the known systems, show the printed patterns on the external side of the film, in superimposition.

As is intuitable, the said technique produces fragile plastic films that break easily, loss their colours and visual elements, for instance owing to rubbing or the like, unless these films are treated with special agents such as fixing agents.

All the said disadvantages and other ones are removed through a new process for the production of pellicles or films to transfer onto suitable supports as need may require in which there is provided a stratiform plurality of colours and there is the possibility of a continues print in the inside of the layers that form the film.

The said very innovative process permits to obtain a product that shows special chromatism, graphics, resistence and adaptability to its support, which makes this product very different from the prior products. Besides, this product permits to reach a high saving in the production cost and a consequent lowering of the market price.

The present invention will be better understood from the following specification that is given as a non-limiting example of one of its possible embodiments.

As is known, transfer films are utilized, for instance in the field of leather and hide industry or the like, to finish natural or synthetic leather or hide. The transfer films are placed on the leather directly in order to give a particular colour or particular graphic/chromatic effects.

The process for producing the films consists in applying a layer of a material such as P.U., P.V.C., acrylic material, rubber, polycarbonate, powders (for instance, in case of pellicles that bear the so-called sequins or spangles) onto a base support that may be a paper support or a support made of another material in order to obtain a coloured or neutral layer that lets see beyond. There are several systems and means to accomplish the said operation, for instance the doctor-scraping operation, the passing of cylinders, the spraying and glazing.

Then, a graphic image is represented on the so-obtained film in a subsequent printing phase such as offset printing, silk-screen printing, thousand-needle printing, flexography, rotogravure process, etc. in one or more colours.

The graphic image is incorporated in a subsequent working phase in which a further layer is applied on the aforesaid layer through a doctor-scraping operation, or passing of cylinders, spraying and glazing or other known system, for instance a manual system or other systems. In this way, the two layers are intimately connected.

Depeding on the requirements, the number of the transparent colour layers may be also higher, in order to obtain a particular chromatic effect, in such a way as the film may consist of a plurality of overlapped layers of different colours to obtain a special chromatic effect.

In the same way, if a different image is wished, it is sufficient to print the wished image or drawing on one or more layers in order to include the image or drawing in its final form between two pellicle layers.

For instance, for the obtention of a special effect with the technique according to the present invention, a pellicle is made of the aforesaid material on a support that is preferably, but not necessarily, a paper support or the like by unwinding the support reel.

Once a film showing the wished colours has been obtained by overlapping one or more transparent layers, the wished drawing or image, for instance the logo of a firm or whatever representation, is printed and finished with further doctor-scraping, cylinder passing, spraying and glazing in order to incorporate the print.

In this way, it is possible to apply the so-obtained film on hide and/or synthetic materials, giving to the logo (of present example) a “fluctuating” effect, because the print seems to be in suspension.

It is obvious that the process according to the present invention permits to obtain and use films according to numberless possibilities which are all included in the scope of protection of the present invention, on taking into account the solution, which contemplates the print or insertion of other materials which are incorporated between more film layers by utilizing the so-described means and materials.

A technician of the field can modify the so-described process and obtain solutions that are to be considered as included in the scope of protection of the invention as further defined by the following claims.

1. Process for producing a plastic pellicle and/or film, characterized in that it comprises a continuous working cycle which includes a plurality of phases through known working means which are placed in succession in order to obtain a multi-layer film in the print finishing of hides, synthetic materials, and/or any support in which the print of graphic shapes, images and/or other decorative elements is included in at least two film layers of which at least one layer lets see beyond.

2. Process for producing a plastic pellicle and/or film according to claim 1, characterized in that the said films are obtained on a suitable support.

3. Process for producing a plastic pellicle and/or film according to claim 2, characterized in that it provides a plurality of transparent layers which are overlapped.

4. Process for producing a plastic pellicle and/or film according to claim 3, characterized in that the said transparent layers may be coloured with different colours in order to obtain films showing different, particular chromatic effects.

5. Process for producing a plastic pellicle and/or film according to claim 4, characterized in that the film obtained by overlapping a plurality of layers incorporating graphic shapes or other, shows a “fluctuating” image characteristic.
